(19) United States
(12) Patent Application Publication
(10) Pub. No.: US 2021/0214849 A1
(43) Pub. Date: Jul. 15, 2021

(54) EXPANDER FOR SOEC APPLICATIONS

(71) Applicant: Haldor Topsøe A/S, Kgs. Lyngby (DK)

(72) Inventor: John Bøgild HANSEN, Humlebæk (DK)

(73) Assignee: Haldor Topsøe A/S, Kgs. Lyngby (DK)

(21) Appl. No.: 17/058,970

(22) PCT Filed: Jul. 9, 2019
(86) PCT No.: PCT/EP2019/068334

§ 371 Date: Nov. 25, 2020

(30) Foreign Application Priority Data
Jul. 12, 2018 (DK) PA 2018 00385

(51) Int. Cl. C25B 1/50; C25B 1/04; C25B 15/08; C25B 9/05; C25B 9/77; C25B 15/027

(52) U.S. Cl. CPC C25B 1/50; C25B 1/04; C25B 15/027; C25B 9/05; C25B 9/77; C25B 15/08

(57) ABSTRACT

In a method for generating various synthesis gases by electrolysis, comprising feeding steam and compressed air to the cathode and anode, respectively, of the electrolysis unit or of the first of a series of electrolysis units into the first of a series of electrolysis units, the electrolysis units are operated under an elevated gas pressure, and the oxygen-rich gas leaving the anode is subsequently expanded down to approximately ambient pressure using a gas expander. The electrolysis units are preferably solid oxide electrolysis cell (SOEC) stacks.

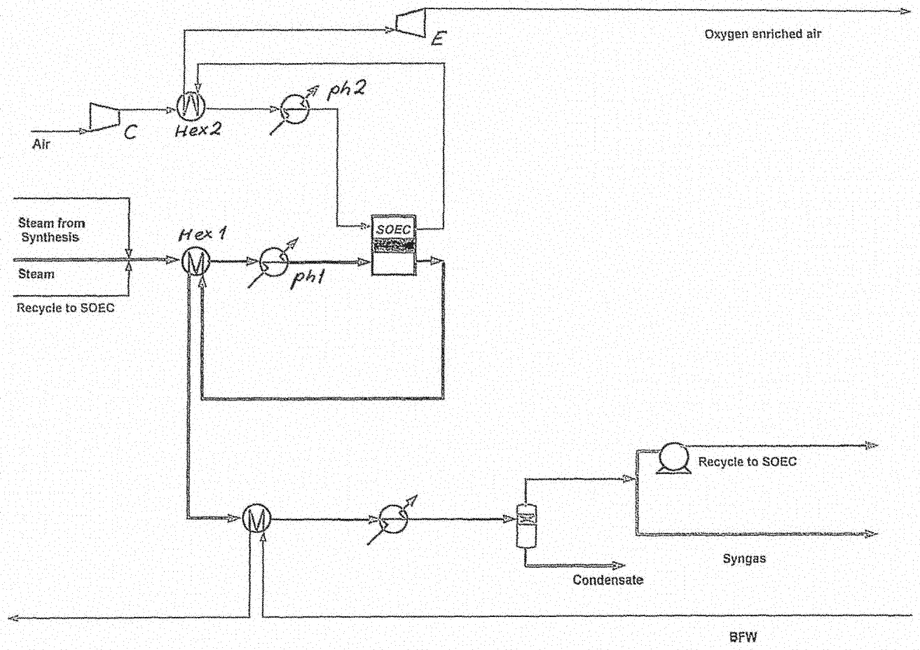

### TECHNICAL FIELD

The present invention relates to electrolysis units, especially a solid oxide electrolysis cell (SOEC) system, generating synthesis gas, which contains hydrogen, carbon monoxide or mixtures of hydrogen, carbon monoxide and carbon dioxide, while operating under elevated pressure. More specifically, the invention relates to the use of an expander in the SOEC system.

### BACKGROUND AND SUMMARY

The synthesis gas generated in the SOEC system can be synthesis gas for the preparation of e.g. ammonia, methane, methanol or dimethyl ether (DME).

The basic idea underlying the present invention consists in generating the synthesis gas while the SOEC system is operated under elevated pressure. The oxygen content at the exit of the anode side of the SOEC system has to be controlled below approximately 50 vol %, which is done by dilution with a stream of compressed air and/or steam. The crux of the invention is applying an expander on this stream to recuperate energy by expanding the gas down to a pressure close to ambient pressure. This is feasible due to the high operating temperature of the SOEC (or other high temperature electrolyzers such as proton conducting solid oxide cells).

For all applications that are using such synthesis gas, it is advantageous to use the gas under pressure, i.e. keeping the SOEC system pressurized.

It would be very beneficial for all SOEC applications if the stacks were operated under pressure, because in that case, the capital and maintenance intensive as well as energy consuming synthesis gas compressors can be omitted. Preliminary laboratory tests indicate that the power consumption in the stacks will remain unchanged up to an operating pressure of at least 20 barg because improved electrode kinetics will outbalance the thermodynamic disadvantages of increasing the pressure.

There is, however, the problem with SOEC technology that the individual cells in the SOEC system can only withstand a very limited differential pressure (<0.2-0.5 bar). This drawback could be overcome by operating the oxygen side of the system in dead-end mode, meaning that there would be no feed flow on the anode side of the cells.

This solution would, however, result in pure oxygen leaving the anode at the high operating temperature of 650-850° C. and pressures up to 40 bar, which will raise severe requirements to the construction materials in the stacks as well as downstream the stacks. Furthermore, there would be severe safety risks associated with this operation mode.

The only SOEC system operating under pressure, which is known so far, is manufactured by sunfire GmbH in Dresden and applied in the HELMETH (which stands for integrated High temperature ELectrolysis and METHanation for effective power to gas conversion) project, but nothing has been published on the details of the air side operation. Idaho National Laboratory (INL) has published papers dealing with the safety of oxygen handling and recommends a maximum of 50% oxygen in the effluent gas. This operation mode is also what has been applied in the Danish Biogas Upgrading project in Foulum. It is achieved by feeding the anode side with air, whereby the generated oxygen is diluted so that an exit concentration of 50 vol % is not exceeded. High pressure steam could also be used for dilution, provided that a steam-tolerant anode is employed.

As the operating mechanism of an SOEC is transfer of oxygen ions through the electrolyte membrane and recombination to molecular oxygen on the anode side, the dominant part or a significant part of the mass flow, which enters the SOEC stacks, leaves on the anode side in the case of steam or carbon dioxide electrolysis, respectively.

The expander will thus recover more energy than invested in compressing the dilution air or in generating the dilution steam.

So the invention relates to a method for generating synthesis gas containing hydrogen, carbon monoxide or mixtures of hydrogen, carbon monoxide and carbon dioxide by electrolysis, said method comprising feeding steam and compressed air to the cathode and anode, respectively, of the electrolysis unit or of the first of a series of electrolysis units, wherein
the electrolysis unit or units is/are operated under an elevated gas pressure, and
the oxygen-rich gas leaving the anode is subsequently expanded down to approximately ambient pressure using an expander.

The electrolysis units are preferably SOEC stacks.

So far, little attention has been paid to ammonia production using synthesis gas produced by electrolysis, especially generated using SOEC stacks. Recently, the design and analysis of a system for the production of “green” ammonia using electricity from renewable energy sources has been described (Applied Energy 192 (2017) 466-476). In this concept, solid oxide electrolysis (SOE) for hydrogen production is coupled with an improved Haber-Bosch reactor, and an air separator is included to supply pure nitrogen.

A typical ammonia-producing plant first converts a desulfurized hydrocarbon gas, such as natural gas (i.e. methane) or LPG (a liquefied petroleum gas, such as propane or butane) or petroleum naphtha into gaseous hydrogen by steam reforming. The hydrogen is then combined with nitrogen to produce ammonia via the Haber-Bosch process

3H₂+N₂→2NH₃

Thus, the synthesis of ammonia (NH₃) requires a synthesis gas (syngas) comprising hydrogen (H₂) and nitrogen (N₂) in a suitable molar ratio of about 3:1.

Ammonia is one of the most widely produced chemicals, and it is synthesized directly using gaseous hydrogen and nitrogen as reactants without precursors or by-products. In its gaseous state, nitrogen is largely available as N₂, and it is normally produced by separating it from atmospheric air. The production of hydrogen (H₂) is still challenging and, for industrial synthesis of ammonia, it is most often obtained from steam methane reforming (SMR) of natural gas. Moreover, when air is used for reforming processes, N₂ is also introduced, thus rendering the need for an air separation unit superfluous, but a clean-up process is necessary to remove oxygen-containing species, such as O₂, CO, CO₂ and H₂O, in order to prevent the catalysts from being poisoned in the ammonia converter. Carbon dioxide is a product of SMR and can be separated and recovered inside the plant. Hydrogen production is therefore a critical process in ammonia synthesis, and a sustainable production of ammonia is desirable to reduce the consumption of a primary source, such as natural gas, and to avoid CO₂ emissions from the process.

The preparation of ammonia synthesis gas by electrolysis has been described in various patents and patent applications. Thus, a method for the anodic electrochemical synthesis of ammonia gas is described in US 2006/0049063. The method comprises providing an electrolyte between an anode and a cathode, oxidizing negatively charged nitrogen-containing species and negatively charged hydrogen-containing species present in the electrolyte at the anode to form adsorbed nitrogen species and hydrogen species, respectively, and reacting the adsorbed nitrogen species with the adsorbed hydrogen species to form ammonia.

In US 2012/0241328, ammonia is synthesized using electrochemical and non-electrochemical reactions. The electrochemical reactions occur in an electrolytic cell having a lithium ion-conductive membrane that divides the electrochemical cell into an anolyte compartment and a catholyte compartment, the latter including a porous cathode closely associated with the lithium ion-conductive membrane.

WO 2008/154257 discloses a process for the production of ammonia that includes the production of nitrogen from the combustion of a stream of hydrogen mixed with air. Hydrogen used to produce the nitrogen for an ammonia combustion process may be generated from the electrolysis of water. Hydrogen produced by electrolysis of water may also be combined with nitrogen to produce ammonia.

An ammonia production with zero CO₂ emission is said to be obtainable with a 40% power input reduction compared to equivalent plants.

A flexible concept for the synthesis of ammonia from intermittently generated H₂ is described (Chem. Ing. Tech. 86 No. 5 (2014), 649-657) and compared to the widely discussed power-to-gas concepts on a technical and economical level.

The electrolytic synthesis of ammonia in molten salts under atmospheric pressure has been described (J. Am. Chem. Soc. 125 No. 2 (2003), 334-335), in which a new electrochemical method with high current efficiency and lower temperatures than in the Haber-Bosch process is used. In this method, nitride ion (N³⁻), produced by the reduction of nitrogen gas at the cathode, is anodically oxidized and reacts with hydrogen to produce ammonia at the anode.

US 2014/0272734 describes a method to produce a syngas stream comprising H₂ and CO by electrolysis using a solid oxide electrolysis cell (SOEC). The method comprises feeding steam to the cathode and a compressed air stream to the anode, but does not make use of a gas expander.

In DE 10 2015 007 732, a method of pressure electrolysis of water to form an oxygen gas stream and a hydrogen gas stream is described. In order to provide an energy-saving process, the oxygen gas stream is relaxed down to ambient pressure in an expander. A similar method is described in WO 2017/118812.

Frattini et al. (Renewable Energy 99 (2016), 472-482) describe a system approach in energy evaluation of different renewable energy sources integrated in ammonia production plants. The impact of three different strategies for renewables integration and scale-up sustainability in the ammonia synthesis process was investigated using thermochemical simulations. For a complete evaluation of the benefits of the overall system, the balance of plant, the use of additional units and the equivalent greenhouse gas emissions have been considered.

Pfromm (J. Renewable Sustainable Energy 9 (2017), 034702) describes and sums up the most recent state of the art and especially the renewed interest in fossil-free ammonia production and possible alternatives to the Haber Bosch process.

Wang et al. (AlChE Journal 63 No. 5 (2017), 1620-1637) deal with an ammonia-based energy storage system utilizing a pressurized reversible solid oxide fuel cell (R-SOFC) for power conversion, coupled with external ammonia synthesis and decomposition processes and a steam power cycle. Pure oxygen, produced as a side product in electrochemical water splitting, is used to drive the fuel cell.

In a recent patent application, the Applicant has disclosed a method for generating synthesis gas for ammonia production by electrolysis, preferably by means of SOEC stacks. Said method avoids any use of an air separation unit (cryogenic, pressure swing adsorption or the like) by taking advantage of the ability of being operated in an endothermal mode, and it provides the necessary nitrogen by burning the hydrogen produced by steam electrolysis by air. In a preferred embodiment, in which SOEC stacks are used, the combustion of hydrogen can take place inside the stacks or between separate stacks.

### BRIEF DESCRIPTION OF THE FIGURES

The FIGURE shows an exemplary embodiment of an SOEC plant.

### DETAILED DESCRIPTION

The present invention is described in more detail in the example which follows. In the example, reference is made to the appended drawing illustrating the principle of the invention.

### Example

This example, as shown in the FIGURE, shows an embodiment of the present invention, representing an SOEC plant delivering hydrogen to generate 1 ton of ammonia.

High pressure steam is imported from the ammonia synthesis and also generated within the SOEC plant. The steam is mixed with recycled hydrogen and pre-heated in a feed/effluent heat exchanger Hex1 on the cathode (fuel) side. It is further pre-heated to the operating temperature of the SOEC, using an electrically heated pre-heater ph1. In this example, the SOEC operates in the so-called thermoneutral mode, so the exit temperature from the stack is equal to the inlet temperature.

On the cathode side, steam is electrolyzed to hydrogen, and the oxygen is transported across the electrolyte to the anode side. The stream of hydrogen mixed with steam is then passed through the above-mentioned feed/effluent heat exchanger Hex1 prior to being further cooled down by generating additional high pressure steam. Finally, the stream is cooled further, and any non-converted steam is condensed out. At this stage, the stream is split into a recycle hydrogen stream and residual steam which is sent to the ammonia synthesis.

On the air side, air is compressed in a compressor C to 40 barg in an amount sufficient to achieve 50% (v/v) oxygen at the exit of the SOEC stacks. The air is pre-heated to 765° C. in a feed/effluent heat exchanger Hex2 before it enters an electrical pre-heater ph2 which further increases the temperature to 785° C., which is the inlet temperature of the stacks. The oxygen-enriched air leaves the stack, and heat is recuperated in the feed/effluent heat exchanger Hex2 before it enters the expander Eat a temperature of 424° C. The gas is expanded down to a pressure of 0.2 barg, whereby the temperature drops to 91° C.

Using an efficiency of 85% for the polytropic efficiency and 5% work loss for the air compressor, and a polytropic efficiency of 78% and 4% work loss for the expander, then the work used and the work recuperated will amount to 311 kW and 356 kW, respectively. It can thus be seen that more power is recuperated (45 kWh per ton of ammonia-equivalent synthesis gas production) than what is spent compressing the dilution air.

In the FIGURE, the compressor and the expander are connected to different lines. They could, however, be connected to a mutual line, which would lead to a better energy efficiency. It could also reduce pressure fluctuations within the cell.

1. A method for generating synthesis gas containing hydrogen, carbon monoxide or mixtures of hydrogen, carbon monoxide and carbon dioxide by electrolysis, said method comprising feeding steam and compressed air to the cathode and anode, respectively, of the electrolysis unit or of the first of a series of electrolysis units, wherein
the electrolysis unit or units is/are operated under an elevated gas pressure, and
the oxygen-rich gas leaving the anode is subsequently expanded down to approximately ambient pressure using a gas expander.

2. Method according to claim 1, wherein the electrolysis units are solid oxide electrolysis cell (SOEC) stacks.

3. Method according to claim 2, wherein the SOEC stacks operate in the so-called thermoneutral mode.

4. Method according to claim 1, wherein the synthesis gas is selected from methanol synthesis gas, methane synthesis gas, ammonia synthesis gas and dimethyl ether (DME) synthesis gas.

5. Method according to claim 2, wherein the synthesis gas is selected from methanol synthesis gas, methane synthesis gas, ammonia synthesis gas and dimethyl ether (DME) synthesis gas.

6. Method according to claim 3, wherein the synthesis gas is selected from methanol synthesis gas, methane synthesis gas, ammonia synthesis gas and dimethyl ether (DME) synthesis gas.

7. Method according to claim 2, wherein the air is compressed in an amount sufficient to achieve 50% (v/v) oxygen at an exit of the SOEC stacks.

8. Method according to claim 2, wherein the steam is mixed with recycled hydrogen and pre-heated in a feed/effluent heat exchanged on a cathode side of the SOEC stacks.

9. Method according to claim 8, wherein, on the cathode side, steam is electrolyzed and oxygen is transported across an electrolyte to an anode side of the SOEC stacks.

10. Method according to claim 8, wherein a stream of hydrogen mixed with steam is passed through the feed/effluent heat exchanger prior to being further cooled down by generated high pressure steam.

11. Method according to claim 10, further comprising splitting the stream into a recycle hydrogen stream and residual steam which is sent to ammonia synthesis.

12. Method according to claim 1, wherein a compressor and the gas expander are connected to different lines.

13. Method according to claim 1, wherein a compressor and the gas expander are connected to a mutual line.

14. Method according to claim 1, wherein the gas is expanded down to a pressure of at most 0.2 barg by the gas expander.

15. Method according to claim 1, further comprising pre-heating the air in a feed/effluent heat exchanger to a first elevated temperature T₁.

16. Method according to claim 15, wherein, following pre-heating, the pre-heated air enters an electrical pre-heater which heats the air to a second elevated temperature T₂, wherein T₂>T₁.

17. Method according to claim 16, wherein the second elevated temperature T₂ is an inlet temperature of the SOEC stacks.

18. Method according to claim 15, wherein, after or as oxygen-enriched air leaves the SOEC stacks, heat is recuperated in the feed/effluent heat exchange, and wherein the oxygen-enriched air subsequently enters the gas expander.

19. Method according to claim 1, wherein the compressed air is compressed to a pressure greater than 20 barg and up to 40 barg.

20. A method for generating synthesis gas containing hydrogen, carbon monoxide or mixtures of hydrogen, carbon monoxide and carbon dioxide by electrolysis, said method comprising feeding steam and compressed air to the cathode and anode, respectively, of the electrolysis unit or of the first of a series of electrolysis units, wherein
the electrolysis unit or units is/are operated under an elevated gas pressure, and
the oxygen-rich gas leaving the anode is subsequently expanded down to approximately ambient pressure using a gas expander,
wherein the compressed air is compressed to a pressure of up to 40 barg, and
the oxygen-rich gas leaving the anode is of temperature from 650 to 850° C.
